(19) United States
(12) Patent Application Publication
(10) Pub. No.: US 2026/0359169 A1
(43) Pub. Date: Nov. 12, 2026

(54) CREATING AND USING DISPOSABLE COPIES OF BACKUP SAVESETS

(71) Applicant: Dell Products L.P., Round Rock, TX (US)

(72) Inventor: Michael Roche, Hamilton (CA)

(73) Assignee: Dell Products L.P., Round Rock, TX (US)

(21) Appl. No.: 19/199,796

(22) Filed: May 6, 2025

(51) Int. Cl. G06F 11/1446

(52) U.S. Cl. CPC G06F 11/1451; G06F 2201/80

(57) ABSTRACT

A system reads backup data for application from application's host storage. The system writes backup data as backup saveset to application's primary backup storage. The system stores information in backup index which maps backup saveset segments to primary backup storage's object which stores backup saveset's segments. The system writes backup data as disposable copy of backup saveset to application's disposable copy storage. The system stores information in backup index which maps disposable copy's segments in backup saveset to disposable copy storage's object which stores disposable copy's segments. The system receives feedback, which identifies problem in disposable copy's segment, from analysis engine that is enabled to access and analyze disposable copy's segments in disposable copy storage. The system uses backup index to identify backup saveset's segment which corresponds to disposable copy's segment which is identified as having problem, and responds to problem using backup saveset's segment.

### BACKGROUND

A data object may be a set of information that is backed up as a unit. If a software error corrupts a data object, or if erroneous data updates the data object, a data protection administrator may restore the data object to a previous state that does not include the corrupted or erroneous data. A backup/restore application performs a backup operation either occasionally or continuously to enable this restoration, storing a copy of each desired data object state (such as the values of the data object and the embedding of these values in a database's data structures) within dedicated backup files. When the data protection administrator decides to reinstate the data object to a previous state, the data protection administrator specifies the desired previous state by identifying a time when the data object was in this previous state, and then instructs the backup/restore application to perform a restore operation to restore a copy of the corresponding backup file(s) for that previous state to the data object.

Backup/restore applications make copies of a production application's data and store these copies as backup files that enable the backup/restore application to restore the production application's data in the event of a corruption, an erroneous update, or an inadvertent or malicious deletion of the production application's data. A data protection server may be scheduled to protect a production application by periodically creating backup files that contain the production application's data. For example, a data protection server may schedule its backup/restore application to create at least one backup file corresponding to each production application which has changed at least some data during the preceding week each Saturday night at midnight.

A data user may copy data in a data center to one or more remote sites, which may be in one or more cloud locations, to have copies of data in case of a data center disaster, and/or the data user may copy data from remote sites to a centralized data center. Data storage systems include recording media that retain digital information, have evolved towards scalable designs that can grow with customer demand by adding storage and computation as necessary, and typically store redundant information. For example, when creating a copy of an enterprise's email system data which includes 100 instances of the same 1 Megabyte (MB) file attachment, a data storage system may store all 100 instances of the same 1 MB file attachment, inefficiently using 100 MB of storage space to store the same 1 MB file attachment. Data deduplication can eliminate redundant copies of information, which can improve the utilization of data storage systems and lower capital expenditure by reducing the total amount of recording media required to meet the capacity needs of data storage systems. Continuing the previous example, a data deduplication system stores only one instance of the same 1 MB file attachment and stores small references to the one stored instance for the 99 subsequent instances.

A backup file may be a copy of part or all of a data set, and may be used to restore part or all of the data set to the condition of the data set at the point in time that the copy was created. A full backup file represents an entire data set at the point in time that the full backup file was created. As a data set increases in size, a full backup file requires more time to be created and requires more storage space. Therefore, a database administrator can supplement a full backup file of a large data set with a series of incremental backup files, or differential backup files, each of which may be a copy of the modifications to a data set since the most recent copy of the entire data set or since the most recent incremental backup file or differential backup file, which stores a copy of recent modifications to the data set.

If the backup/restore application identifies that the most recently created backup file for a data set is not a full backup file, the backup/restore application can combine the most recently created backup file for the data set with other backup files created for the data set into a synthetic full copy of the backed-up dataset. For example, after a backup/restore application creates a full backup file of a hard disk's entire data set, a user modifies data blocks in only one of the hard disk sectors, and the backup/restore application subsequently creates an incremental backup file of the hard disk's modified sector. Then the backup/restore application combines the current incremental backup file of the hard disk's modified sector with the previous full backup file of the hard disk to create a synthetic full backup file that includes the hard disk's recently modified sector as a replacement for the previous version of the modified sector and also includes the rest of the hard disk's previous data set.

When backup files are stored to various types of storages, the backup files can be identified and organized efficiently as parts of a backup saveset. A backup saveset can be a container for a specific data protection job, capturing the state of files, folders, and backed-up data for an application at a particular point in time, typically including metadata such as the date, time, and files included, along with an internal identifier for tracking. System users may use a less formal definition to remember or understand a backup saveset as the set of everything that is saved to back up the data and the metadata for an application.

When being copied from or to a data storage system, a data file, a data object, and/or a backup saveset may be divided into data segments. A data deduplication system can receive data segments, compare these received data segments against previously stored data segments, identify which received data segments are unique because they have not been previously stored, and store the unique data segments. When a comparison identifies a received data segment as a duplicate of a data segment that has previously been stored as unique, a data deduplication system replaces the duplicate data segment with a small reference that points to the previously stored data segment.

A deduplication system typically does not determine whether a data segment is a duplicate data segment or a unique data segment by directly comparing this data segment against previously stored data segments which were previously determined to be unique data segments. For example, a deduplication system would waste system resources by directly comparing thousands of bytes in each of many data segments which were formed from a client's data object or data file against thousands of bytes in millions of data segments which have already been identified and stored as unique data segments. Instead, a fingerprint that uniquely identifies a data segment may be generated for each data segment, such as by applying a SHA-1 hash function to create a unique 20-byte fingerprint for each data segment. Consequently, a deduplication system can conserve system resources by more efficiently comparing 20-byte fingerprints for each of many data segments formed from a client's data object or data file against 20-byte fingerprints for millions of data segments which have already been identified and stored as unique data segments.

Whether a backup file is a full backup file, an incremental backup file, a differential backup file, a data segment a backup file of, a deduplicated data segment of a backup file, and/or a backup file represented by a unique fingerprint, or part of a backup saveset, such a backup file may be infected by malware. Malware (malicious software) is any software code or computer program intentionally written to harm a computer system or its users. Once present on a computer, malware can leak sensitive details such as personal information, business information and passwords, can give control of the system to an attacker, and can corrupt or delete data permanently. Types of malware include viruses, worms, ransomware, trojan horses, and spyware.

A computer virus is a specific type of malware that embeds itself in some other executable software, including the operating system itself, on the target computer without the user's knowledge and consent. When it is run, the virus can produce copies of itself and insert them into other programs or executable files on the target computer or another computer, and that usually performs a harmful action, such as destroying data.

In contrast to a virus which requires a user to run an infected software or operating system for the virus to spread, a worm spreads itself. A worm is a stand-alone malware that actively transmits itself over a network to infect other computers and spread between programs, applications, and devices without the need for human interaction. A worm is self-replicating malware that can copy itself without infecting files.

Ransomware is malware that installs itself onto a user's computer, encrypts their files, then displays a pop-up message informing the user that their files have been encrypted. The ransomware prevents the user from accessing their files until the user pays a ransom, usually in Bitcoin, to have their files decrypted and recovered.

A Trojan horse is malware that hides itself within desired or legitimate software or misrepresents itself to masquerade as a regular, helpful program or utility in order to persuade a victim to install it. A Trojan horse usually carries a hidden destructive function that is activated when the application is started, such as creating a secret backdoor on the affected device to enable access by an attacker who can cause damage. The term is derived from the Ancient Greek story of the Trojan horse that was used to invade the city of Troy by stealth.

Spyware is a type of malware that can display unsolicited advertisements, redirect affiliate marketing revenues, monitor users' web browsing, and/or secretly gather information from an infected computer and transmit the sensitive information back to an attacker. One of the most common forms of spyware are keyloggers, which record all of a user's keyboard inputs/keystrokes, which allows hackers to harvest usernames, passwords, bank accounts, credit card numbers, and other confidential information. Instead of spreading like viruses, spyware programs are generally installed by exploiting security holes, but they can also be hidden and packaged together with unrelated user-installed software.

Cybersecurity uses signature-based detection to identify malware by matching specific patterns, or “signatures,” of scanned code against known patterns or signatures of malicious code in a database. Security researchers analyze malware samples and identify recurring patterns or sequences within them, compile these patterns or sequences as signatures, and store these signatures in a malware signature database. These signatures are unique sequences of bytes or code that are characteristic of certain malware families. Typically, antivirus or antimalware software scans files and network traffic activities, compare the signatures of the scanned files and activities against the malware signature database, and if a match is found, the software flags the file or network traffic activity as a potential malware infection.

Additionally, an analysis engine can scan backup savesets and then compare signatures of the scanned segments in the backup savesets against a malware signature database, and if a match is found, the analysis engine provides a backup/restore application with feedback that identifies any matching segments in the backup saveset as having a potential malware infection. Examples of signatures include file hashes, which are unique digital fingerprints of files that are used to identify specific malware versions, byte sequences, which are specific patterns of bytes within code or network packets, string matches, which are strings or commands that are known to be malicious, and file header information, which are file headers that have malicious characteristics. In essence, signature-based detection is a foundational technique in cybersecurity, relying on the identification of known patterns to detect and prevent malware infections.

Analysis products, such as virus scan, Index Engines, and Moogsoft, are increasingly being used to perform analysis of the output of backup/restore applications. Such analysis is frequently expanding, including use cases for anomaly detection, such as a potential malware infection in recently stored backup files. Artificial Intelligence extensions of analysis of backup data is also an emerging concept. Backup products produce application-specific streams of data with structure such as headers, checksums, and backup data. Analysis engines are being “trained” to read these backup files.

The primary purpose of primary backup files and secondary backup files in a backup saveset is data recovery. These backup files are solely intended to be a means of recovering data either in the event of a disaster or as incremental recovery. The overlap of the need to analyze backup files to detect anomalies such as a potential malware infection versus their primary role of data protection are competing needs. Analysis engines which can detect anomalies such as potential malware infections need to have access to backup files via direct access to backup files and/or copies of the backup files on primary backup storage or secondary backup storage. Backup files in backup savesets are now being referenced and accessed for a purpose not related to recovery.

Compliance issues on accessing production backup files include potential corruption and/or modification of the production backup files by the analysis engine attempting to detect anomalies such as potential malware infections. An analysis engine attempting to identify potential malware infections on backup copies while a backup/restore application is attempting to restore data from the same backup copies will create competing Input/Output bandwidth considerations between the various end points. Consequently, critical backup/recovery windows are impacted by analysis engines accessing backup files to detect anomalies such as potential malware infections. Alternative solutions to such challenges which attempt to completely separate the backup files used for the competing purposes are plagued by the problems that exist because a copy of a backup saveset which is created outside of the backup application cannot be efficiently referenced back to the primary backup savesets stored in primary backup storage or secondary backup savesets stored in secondary backup storage. As a result, awareness of detected anomalies such as potential malware infections cannot be conveyed to a backup/restore application in a timely manner.

FIG. 1 provides a pictorial of the workflow 100 that is currently in place when an analysis engine directly accesses backup files in backup savesets stored on primary backup storage or secondary backup storage for the purposes of detecting anomalies such as potential malware infections in the backup files. The backup/restore application 102 reads (104) backup data from the host storage 106, writes (108) the backup data as a backup saveset to the primary backup storage 110, and indexes (112) the primary backup saveset to the backup index 114. Next, the backup/restore application 102 writes (116) the primary backup saveset from the primary backup storage 110 to the secondary backup storage 118, and indexes (120) the secondary backup saveset in the backup index 114.

Then the analysis engine 122 analyzes (124) the primary backup saveset in the primary backup storage 110 and/or analyzes (126) the secondary backup saveset in the secondary backup storage 110 to detect any anomalies in the primary backup saveset and/or the secondary backup saveset. Based on the results of the analysis, the analysis engine 122 provides (128) feedback, which identifies segments in the primary backup savesets and/or the secondary backup savesets that have signatures which match malware signatures, to the backup/restore application 102. In response to such feedback, the backup/restore application 102 uses the backup index 114 to identify the segments of the backup savesets which are identified as having potential malware infections, and then isolate any identified segments.

The input/output bandwidth which is available for the primary backup storage 110 and the secondary backup storage 118 may be limited when the backup/restore application 102 recovers a backup saveset from the primary backup storage 110 or the secondary backup storage 118 and restores the backup saveset to the host storage 106. When the analysis engine 122 analyzes the primary backup savesets stored in the primary backup storage 110 or analyzes the secondary backup savesets stored in the secondary backup storage 118, this load on the input/output bandwidth for the primary backup storage 110 and the secondary backup storage 118 can adversely affect the input/output bandwidth which is available for the backup/restore application 102 to recover the backup savesets from the primary backup storage 110 or from the secondary backup storage 118. Consequently, the critical recovery windows are negatively impacted by the analysis engine 122 analyzing any of the backups savesets stored on the primary backup storage 110 or the secondary backup storage 118. Furthermore, the backup/restore application 102 can guarantee that the primary backup savesets stored on the primary backup storage 110 and the secondary backup savesets stored on the secondary backup storage 118 meet all compliance requirements only if no entity has had access to the primary backup storage 110 or the secondary backup storage 118. However, if the analysis engine 122 has accessed the primary backup storage 110 or the secondary backup storage 118 to analyze the primary backup savesets stored on the primary backup storage 110 or the secondary backup savesets stored on the secondary backup storage 118, the backup/restore application 102 can no longer guarantee compliance of the backup savesets because the analysis engine 122 could have corrupted or modified the primary backup savesets stored on the primary backup storage 110 or the secondary backup savesets stored on the secondary backup storage 118.

FIG. 2 provides a pictorial of the workflow 200 that is currently in place when an analysis engine accesses a copy of a backup saveset which was copied outside of the backup/restore application's awareness, and therefore does not directly access the primary backup savesets stored on the primary backup storage or the secondary backup savesets stored on the secondary backup storage. The backup/restore application 202 reads (204) backup data from the host storage 206, writes (208) the backup data as a backup saveset to the primary backup storage 210, and indexes (212) the primary backup saveset to the backup index 214. Next, the backup/restore application 202 writes (216) a copy of the primary backup saveset from the primary backup storage 210 to the secondary backup storage 218, and indexes (220) the secondary backup saveset to the backup index 214.

Then the backup/restore application 202 copies (222) the primary backup saveset from the primary backup storage 210 to the external copy storage 224 or copies (226) the secondary backup saveset from the secondary backup storage 218 to the external copy storage 224, but does not index the external copies of the backup savesets to the backup index 214. The analysis engine 228 analyzes (230) the external savesets stored to the external copy storage 224, but does not efficiently provide feedback to the backup/restore application 202, which does not have awareness of the external savesets and therefore any feedback from the analysis engine 228 is limited. Since a copy of a backup saveset which is created outside of the backup/restore application 202 cannot be efficiently referenced back to the primary backup saveset or the secondary backup saveset, providing awareness of anomalies, such as the identification of a segment in a copy of a backup saveset that has a signature which matches a malware signature, to the backup/restore application 202 cannot be achieved in a timely manner.

### BRIEF DESCRIPTION OF THE DRAWINGS

FIG. 1 illustrates a block diagram of an example of a traditional sequence diagram for an analysis engine that directly accesses backup savesets on primary backup storage or secondary backup storage;

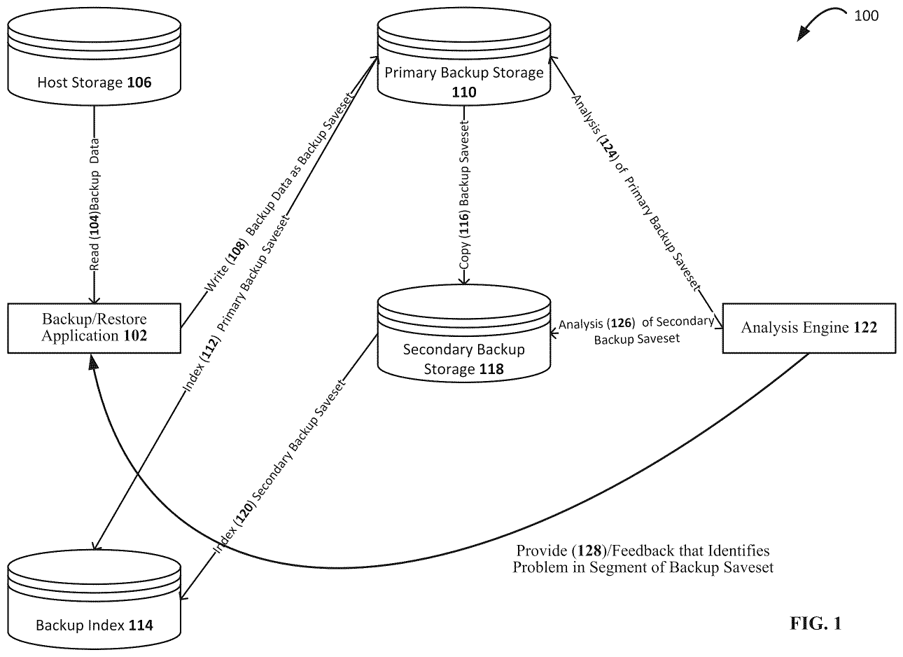

FIG. 2 illustrates a block diagram of an example of a traditional sequence diagram for an analysis engine that accesses a copy of a backup saveset which was copied outside of a backup/restore application's awareness;

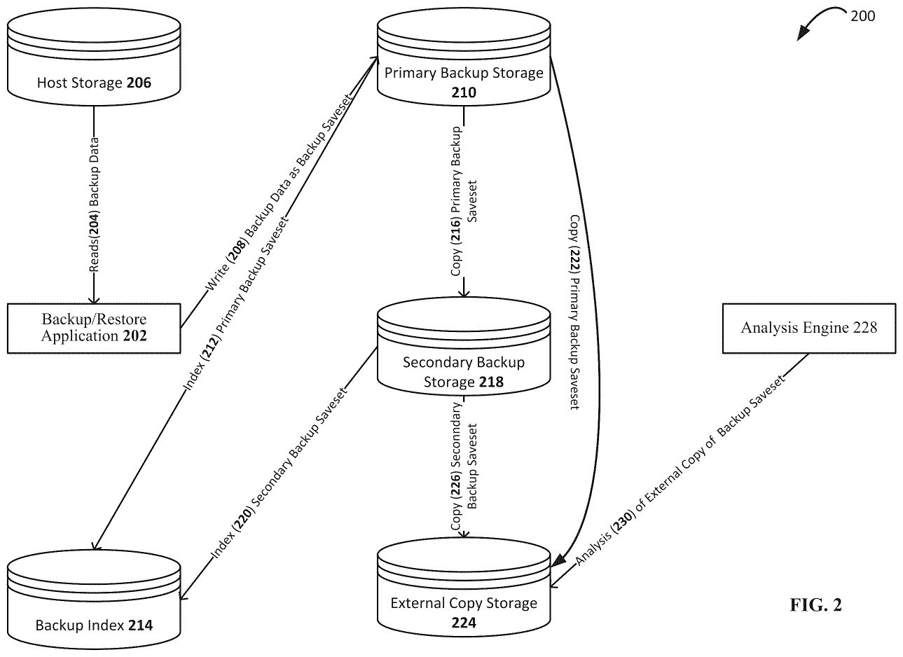

FIG. 3 illustrates a block diagram of an example of sequence diagram for creating and using disposable copies of backup savesets, under an embodiment;

FIG. 4 illustrates a block diagram of an example system for creating and using disposable copies of backup savesets, under an embodiment;

FIG. 5 is a flowchart that illustrates an example method for creating and using disposable copies of backup savesets, under an embodiment; and

FIG. 6 is a block diagram illustrating an example hardware device in which the subject matter may be implemented.

### DETAILED DESCRIPTION

Embodiments create and use disposable copes of backup savesets. A system reads backup data for an application from a host storage for a host of the application, writes the backup data as a backup saveset to a primary backup storage for the application, and stores information in a backup index which maps segments of the backup saveset to an object in the primary backup storage which stores the segments of the backup saveset. The system writes the backup data as a disposable copy of the backup saveset to a disposable copy storage for the application, stores information in the backup index which maps segments of the disposable copy of the backup saveset to an object in the disposable copy storage which stores the segments of the disposable copy. The system receives feedback, which identifies a problem in a segment of the disposable copy, from an analysis engine that is enabled to access and analyze the segments of the disposable copy in the disposable copy storage. The system uses the backup index to identify a segment of the backup saveset which corresponds to the segment of the disposable copy which is identified as having the problem, and responds to the problem using the segment of the backup saveset.

For example, a Dell Corporation's NetWorker® backup/restore application reads recently changed SQL data to back up a Microsoft SQL database application from a host storage, writes the SQL data as an incremental backup file (which records only recent changes to the SQL database) in a backup saveset to an on-premises primary backup storage, while indexing the incremental backup file to a backup index to record which data segments in the incremental backup file are stored in which container objects in the on-premises primary backup storage. While writing the incremental backup file to the primary backup storage, the NetWorker® backup/restore application concurrently writes the same backup SQL data as a disposable copy of the incremental backup file in a backup saveset to an on-premises dedicated disposable copy storage, while also indexing the disposable copy of the incremental backup file to the backup index to record which data segments in the disposable copy of the incremental backup file are stored in which container objects in the disposable copy storage. Although indexed for quick access via the backup index, the disposable copies are not used for backup purposes, thereby eliminating any bandwidth competition between the NetWorker® backup/restore application and the analysis engine, which is free to access and analyze the disposable copies for anomalies such as potential malware infections. Upon analyzing the disposable copy and identifying the disposable copy's data segment number 95 which has a signature that matches a malware signature, the analysis engine conveys this problem to the NetWorker® backup/restore application, which can quickly and easily identify the indexed data segment number 95 in the disposable copy storage, and use the backup index to quickly identify the corresponding data segment number 95 in the backup saveset, and solve the potential malware infection problem by isolating the data segment number 95. When the analysis engine completes the analysis of the disposable copies, the NetWorker® backup/restore application deletes all of the disposable copies, thereby preparing for storage of subsequent disposable copies.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. In some embodiments, operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

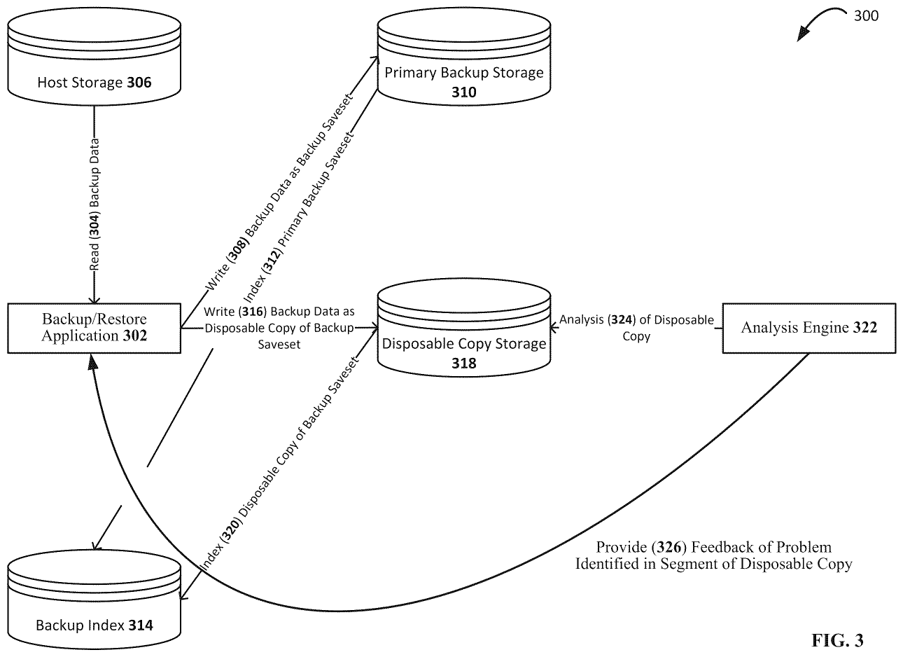

FIG. 3 provides a pictorial of the workflow 300 that is in place when an analysis engine accesses a disposable copy of a backup saveset, which is created with full awareness by the backup/restore application so that any feedback from the analysis engine is direct. The backup/restore application 302 reads (304) backup data from the host storage 306, writes (308) the backup data as a backup saveset to the primary backup storage 310, and indexes (312) the primary backup saveset to the backup index 314. The backup/restore application 302 also writes (316) the backup data as disposable copies of the backup saveset to the disposable copy storage 318, and indexes (320) the disposable copy of the backup saveset to the backup index 314.

The analysis engine 322 analyzes (324) the disposable copy of the backup saveset stored to the disposable backup storage 318, and efficiently provides (326) feedback, which can associate a problem with any segment of the disposable copy in the disposable copy storage 318, to the backup/restore application 302. In response to such feedback the backup/restore application 302 uses the backup index 314 to identify the segment of the backup saveset that corresponds to the segment of the disposable copy identified with the potential malware infection. After the backup index is used to identify the corresponding segment of the backup saveset, the backup/restore application 302 responds to the problem by isolating the corresponding segment of the backup saveset.

The disposable copy of the backup saveset exists for the sole purpose of analysis outside of the backup/restore application 302, not for the purpose of data recovery, for which it never can be used. Therefore, the disposable copy of the backup saveset may be indexed with full awareness within the backup/restore application 302, without the indexing being used for recovery. The loss of a disposable copy of a backup saveset is not critical to the backup/restore application 302, but the backup/restore application 302 is fully aware of the existence, loss, and purpose of the disposable copy. Since the disposable copy of the backup saveset is equivalent in structure to the backup saveset stored in the primary backup storage 310, the analysis engine 322 does not need to be retrained to access a new format for the disposable copy of the backup saveset. The primary backup saveset in the primary backup storage 310 and the secondary backup saveset in the secondary backup storage (not depicted in FIG. 3) are kept separate from the disposable copy of the backup saveset stored in the disposable copy storage 318 to meet compliance needs.

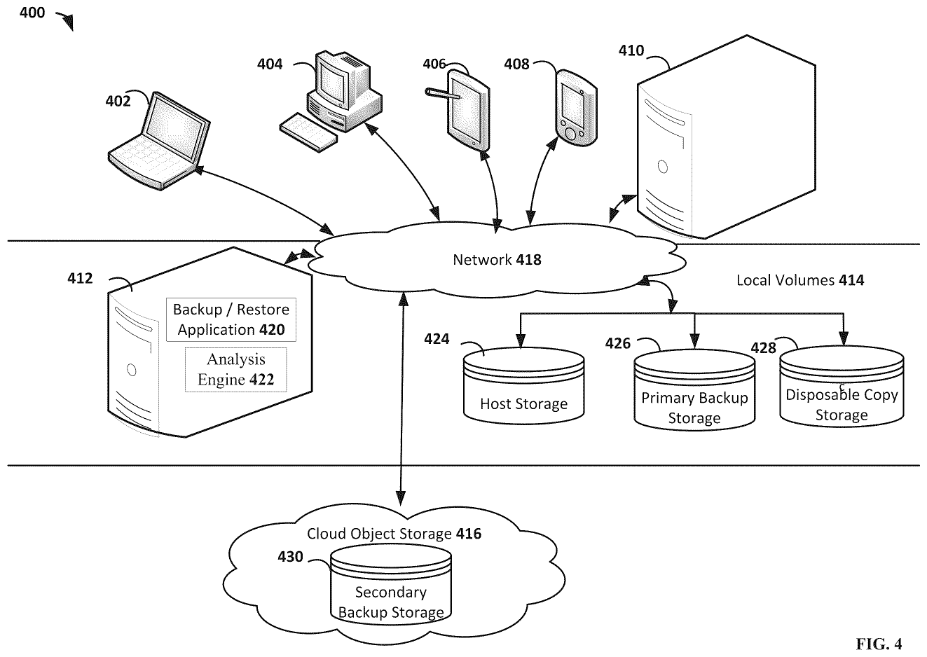

FIG. 4 illustrates a diagram of a system 400 for creating and using disposable copies of backup savesets. As shown in FIG. 4, the system 400 may illustrate a cloud computing environment in which data, applications, services, and other application resources are stored and delivered through shared data centers and appear as a single point of access for the users. The system 400 may also represent any other type of distributed computer network environment in which servers control the storage and distribution of application resources and services for different client users.

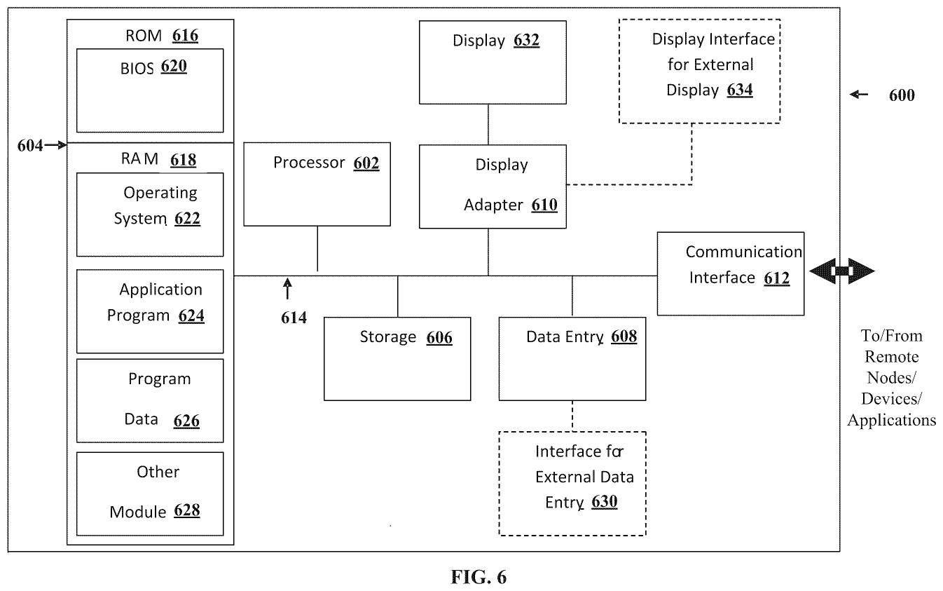

In an embodiment, the system 400 represents a cloud computing system that includes a first client 402, a second client 404, a third client 406; a fourth client 408; a fifth client 410, and a data protection server 412. The first client 402 may be a laptop computer 402, the second client 404 may be a desktop computer 404, the third client 406 may be a tablet computer 406, the fourth client 408 may be a smart phone 408, and the fifth client 410 may be a server 410. The clients 402-410 and the data protection server 412 may each be substantially similar to the system 600 depicted in FIG. 6 and described below. The clients 402-410, the data protection server 412, the local volumes 414, and a cloud object storage 416 communicate via a network 418.

The data protection server 412 includes a backup/restore application 420, and an analysis engine 422, the local volumes 414 include a host storage 424, a primary backup storage 426, and a disposable copy storage 428, and the cloud object storage 416 includes a secondary backup storage 430. FIG. 4 depicts the system 400 with five clients 402-410, one server 412, one set of local volumes 414, one cloud object storage 416, one network 418, one backup/restore application 420, one analysis engine 422, one host storage 424, one primary backup storage 426, one disposable copy storage 428, and one secondary backup storage 430. However, the system 400 may include any number of each of the clients 402-410, the server 412, the set of local volumes 414, the cloud object storage 416, the network 418, the backup/restore application 420, the analysis engine 422, the host storage 424, the primary backup storage 426, the disposable copy storage 428, and the secondary backup storage 430.

Although FIG. 4 depicts all of the backup/restore application 420 and all of the analysis engine 422 residing completely on the data protection server 412, any or all of the backup/restore application 420 and any or all of the analysis engine 422 may reside in any combination of partially on the data protection server 412, partially on the clients 402-410, partially on the cloud object storage 416, and partially on another server which is not depicted in FIG. 4. While FIG. 4 depicts all of the host storage 424, the primary backup storage 426, and the disposable copy storage 428 residing completely on the set of local volumes 414, any or all of each of the host storage 424, the primary backup storage 426, and/or the disposable copy storage 428 may reside in any combination of partially on the local volumes 414, partially on the cloud object storage 416, partially on the clients 402-410, partially on another server which is not depicted in FIG. 4, and completely on the cloud object storage 416.

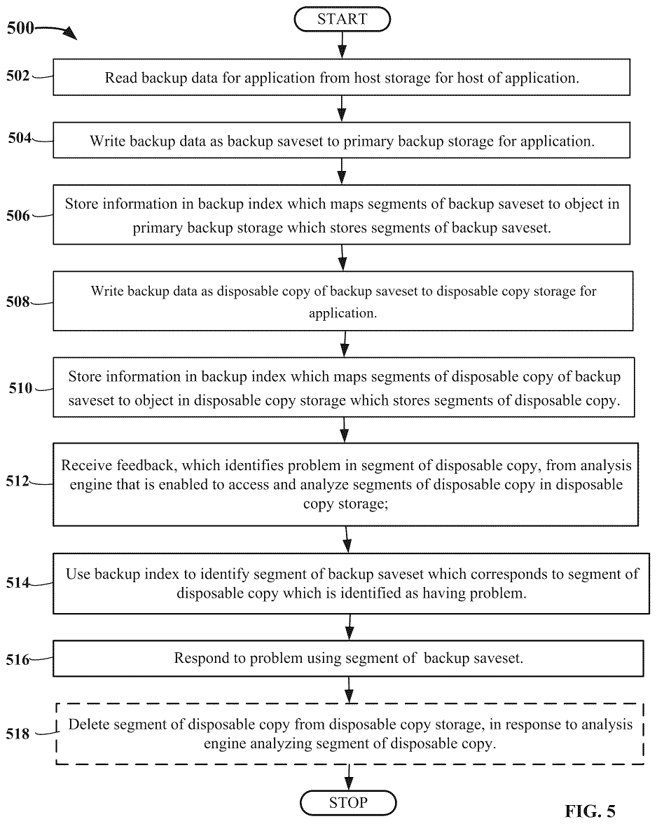

FIG. 5 is a flowchart 500 that illustrates a method for creating and using disposable copies of backup savesets. Flowchart 500 depicts method acts illustrated as flowchart blocks for certain steps involved in the system elements 402-430 depicted by FIG. 4.

Backup data for an application is read from a host storage for a host of the application, block 502. A system begins the process of backing up data. For example, and without limitation, this can include a Dell Corporation's NetWorker® backup/restore application 420 reading recently changed SQL data to back up a Microsoft SQL database application from the host storage 424. In this example, the backup data is defined to be the recently changed data which is stored in an incremental backup file or a differential backup file, whereas in a different example based on a full backup file, the backup data is defined as all of the data associated with at least one application.

Backup data can be the information in a computer that is taken and stored elsewhere so that it may be used to restore the original information after an information loss event. An application can be a program or piece of software designed and written to fulfill a particular purpose of a user. A host can be a computer that mediates multiple access to any application(s) mounted on it. A host storage can be the retention space located on a computer and its related infrastructure.

After reading backup data, the backup data is written as a backup saveset to a primary backup storage for the application, block 504. The system writes the primary backup saveset. By way of example and without limitation, this can include the NetWorker® backup/restore application 420 writing the recently changed SQL data as an incremental backup file (which records only recent changes to the SQL database) as a backup saveset to the on-premises primary backup storage 426. A backup saveset can be a container for a specific job, capturing the state of files, folders, and backed-up data for an application at a particular point in time, typically including metadata such as the date, time, and files included, along with an internal identifier for tracking. A primary backup storage can be the retention on a computer of retrievable data that is used in the initial response to restore the data after a data loss.

Following writing a backup saveset, information is stored in a backup index which maps segments of the backup saveset to an object in the primary backup storage which stores the segments of the backup saveset, block 506. The system indexes the primary backup saveset for subsequent access. In embodiments, this can include the NetWorker® backup/restore application 420 indexing the incremental backup file as part of the backup saveset to a backup index to record which data segments in the incremental backup file are stored in which container objects in the primary backup storage 426.

Information can be data as processed, stored, or transmitted by a computer. A backup index can be a metadata structure that describes the contents of a data file used for restoration, enabling faster and more efficient data retrieval and restoration processes. A segment can be any one of the parts into which something is or may be divided. An object can be a data construct that provides a description of something which may be utilized by a computer.

Having read backup data, the backup data is written as a disposable copy of the backup saveset to a disposable copy storage for the application, block 508. The system writes disposable copies of backup savesets which may be analyzed independently of any recovery the backup saveset. For example, and without limitation, this can include the NetWorker® backup/restore application 420 writing the same backup SQL data as a disposable copy of the incremental backup file in a backup saveset to a dedicated disposable copy storage 428, while concurrently writing the incremental backup file to the primary backup storage 426. Writing the backup data to the primary backup storage may be concurrent with writing the backup data to the disposable copy storage. By creating a backup saveset to be stored in the primary backup storage 426 and simultaneously creating the disposable copy of the backup saveset to be stored in the disposable copy storage 428, the NetWorker® backup/restore application 420 is able to read the backup data only once, and yet write the backup data to two separate storages at the same time.

A disposable copy can be information which is duplicated and then intended to be used once, or until no longer useful, and then deleted. A disposable copy storage can be the retention on a computer of duplicate data that is used for analysis and then deleted. Concurrent can be existing, happening, or done at the same time.

Since the retention time of a disposable copy of a backup saveset may be decoupled from the need to recover, the disposable copy may be deleted after it is analyzed. The disposable copy of the backup saveset may be associated with a retention time that is shorter than a retention time that is associated with the backup saveset. For example, the primary backup storage 426 retains the backup saveset for 90 days, while the disposable copy storage 428 retains the disposable copy of the backup saveset for only 5 days. A retention time can be a duration for keeping something in storage or memory. Shorter can be less in size or magnitude.

The disposable copy storage may be associated with a resource that is inexpensive, including a storage capacity that is smaller, compared to a resource that is associated with the primary backup storage. For example, the primary backup storage 426 uses solid state drives to store the backup saveset, while the disposable copy storage 428 uses hard drives to store the disposable copy of the backup saveset.

A resource can be an asset that can be drawn on in order to function effectively. Inexpensive can be costing a small amount of money. A storage capacity can be the total amount of data that a device, such as a hard drive or a solid state drive, can hold. Smaller can be less in size or magnitude.

The disposable copy of the backup saveset exists for the sole purpose of analysis outside of the backup/restore application 420, not for the purpose of data recovery, for which it can never be used. Therefore, the disposable copy of the backup saveset may be indexed with full awareness within the backup/restore application 420, without being used for recovery. The loss of a disposable copy of a backup saveset is not critical to the backup/restore application 420, but the backup/restore application 420 is fully aware of the existence, loss, and purpose of the disposable copy. Since the disposable copy of the backup saveset is equivalent in structure to the backup saveset stored in the primary backup storage 426, the analysis engine 422 does not need to be retrained to access a new format for the disposable copy of the backup saveset. The primary backup savesets stored in the primary backup storage 426 and the secondary backup saveset stored in the secondary backup storage 430 are kept separate from the disposable copies of the backup saveset stored in the disposable copy storage 428 to satisfy each of the compliance needs.

After writing a disposable copy of a backup saveset to a disposable copy storage, information is stored in a backup index which maps segments of the disposable copy of the backup saveset to an object in the disposable copy storage which stores the segments of the disposable copy, block 510. The system indexes the disposable copy of the backup saveset for independent use of analysis, such as detecting segments which have signatures that match malware signatures. By way of example and without limitation, this can include the NetWorker® backup/restore application 420 indexing the disposable copy of the incremental backup file in the backup saveset to the backup index to record which data segments in the disposable copy of the incremental backup file are stored in which container objects in the disposable copy storage 428.

Following the indexing of the disposable copy of the backup saveset, feedback is received which identifies a problem in a segment of the disposable copy, from an analysis engine that is enabled to access and analyze segments of the disposable copy in the disposable copy storage, block 512. The system receives feedback that identifies problems such as malware in segments of the disposable copy. In embodiments, this can include the NetWorker® backup/restore application 420 receiving feedback from the analysis engine 422 specifying that after analyzing the segments of the disposable copy, a problem was identified in the data segment number 95 of the disposable copy of the backup saveset, which has a signature which matches a malware signature. Although indexed for quick access via the backup index, the disposable copy is not used for backup purposes, thereby eliminating any bandwidth competition between the NetWorker® backup/restore application 420 and the analysis engine 422, which is free to access and analyze the segments of the disposable copy and detect anomalies, such as a segment that has a signature which matches a malware signature.

Feedback can be information about reactions to a product or service which is used as a basis for improvement. A problem can be a matter or situation regarded as unwelcome or harmful and needing to be dealt with and overcome. An analysis engine can be a software tool that processes large datasets, and provides insights for decision-making.

The primary backup storage may be inaccessible by an analysis engine which may identify the problem based on matching signatures for malware and the segment of the disposable copy. For example, the analysis engine 422 cannot access the primary backup storage 426, but can access the disposable copy storage 428 to analyze the disposable copy to determine if any segments of the disposable copy have signatures which match malware signatures. Inaccessible can be not able to be used. Malware can be software that is specifically designed to disrupt, damage, or gain unauthorized access to a computer system. A matching signature can be a similarity between patterns and/or sequences of code or bytes from at least two sources of code or bytes.

The feedback identifying a problem in the segment of the disposable copy may be provided by the analysis engine via at least one of an application programming interface, a command line interface, and a representational state transfer (REST). For example, the analysis engine 422 uses an application programming interface to provide feedback about the segment number 95 in the disposable copy having a signature that matches a malware signature. An application programming interface can be a connection between computers or computer programs. A command line interface can be a means for interacting with a computer program by inputting a sequence of text. A representational state transfer can be a software architectural style.

Having received feedback which identifies a problem in a segment of a disposable copy, the backup index is used to identify the segment of the backup saveset which corresponds to the segment of the disposable copy which is identified as having the problem, block 514. The system identifies the segment of the backup saveset which matches the segment of the disposable copy which is identified as having a problem. For example, and without limitation, this can include the NetWorker® backup/restore application 420 using the backup index to quickly and easily identify the data segment identified as having a potential malware infection, which is segment number 95 in the disposable copy storage 426, and quickly identify the corresponding data segment number 95 in the backup saveset. Although this example describes the segment number in the disposable copy of the backup saveset stored in the disposable copy storage 428 and the segment number in the backup saveset stored in the primary backup storage 426 being segment numbers which are identical to each other, in some embodiments the segment numbers are different from each other but the NetWorker® backup/restore application 420 uses the backup index to match the segment for the backup saveset with the segment for the disposable copy of the backup saveset.

After identifying a segment of a backup saveset which corresponds to the segment of the disposable copy which is identified as having a problem, the segment of the backup saveset is used to respond to the problem, block 516. The system uses the segment of the backup file which has been indirectly identified as having a problem to respond to the problem. By way of example and without limitation, this can include the NetWorker® backup/restore application 420 isolating the data segment number 95 of the backup saveset. As described by this preceding example, responding to a problem identified for a segment of a disposable copy of a backup saveset may include isolating a segment of a backup saveset.

Following the analysis engine analyzing a segment of the disposable copy, the segment of the disposable copy is optionally deleted from the disposable copy storage, block 518. The system disposes of the disposable copies when they are no longer needed for analysis. In embodiments, this can include the NetWorker® backup/restore application 420 determining that the analysis engine 422 completed the analysis of the segments of the disposable copy, and then deleting all of the segments of the disposable copy, thereby preparing for storage of subsequent disposable copies.

Although FIG. 5 depicts the blocks 502-518 occurring in a specific order, the blocks 502-518 may occur in another order. In other implementations, each of the blocks 502-518 may also be executed in combination with other blocks and/or some blocks may be divided into a different set of blocks.

Although the following paragraphs describe Dell Corporation's PowerProtect® backup/restore application, Dell Corporation's NetWorker® backup/restore application, and Dell Corporation's Avamar® backup/restore application as examples of the backup/restore application 420, the backup/restore application 420 may be another type of backup/restore application which provides the backup/restore functionalities described in the sections above. The data protection server 412 may be another type of backup server which provides the backup/restore functionalities described in the Background section.

The backup/restore application 420 may be a Dell Corporation's PowerProtect® Data Manager backup/restore application, which supports Microsoft SQL/Exchange/DB2/Oracle/SAP Oracle/SAP HANA/Filesystem/Hadoop and ProtectPoint solutions, as well as Kubernetes containers and virtual environments. Providing more than just access to backups and restore capabilities, PowerProtect® Data Manager provides analytics and reuse for development/testing, leverages the cloud to extend data center capabilities, and protects cloud native applications. PowerProtect® Data Manager's automated orchestration of fail-over, failback, and testing simplifies production disaster recovery scenarios. PowerProtect® Data Manager empowers data and application owners to perform self-service backup and restore operations from native applications directly to Dell protection storage appliances.

When superior performance is crucial, PowerProtect® Data Manager provides a direct path between Dell tier one storage and PowerProtect® Data Domain and/or Data Domain. PowerProtect® Data Manager extends protection to the cloud by tiering backups to cloud storage for long-term retention, thereby maximizing retention and access to backups without impacting on-premises protection storage resources. When tiering is not enough, PowerProtect® Data Manager enables disaster recovery to the public cloud. At the same time, PowerProtect® Data Manager's governance control provides information technology (IT) with the necessary oversight and governance to ensure compliance, making even the strictest service level objectives obtainable.

The backup/restore application 420 may be a Dell Corporation's NetWorker® backup/restore application, which is a suite of enterprise level data protection software that unifies and automates backup to tape, disk-based, and flash-based storage media across physical and virtual environments for granular and disaster recovery. Cross-platform support is provided for many environments, including Microsoft® Windows®. A central NetWorker® server manages a data zone that contains backup clients and NetWorker® storage nodes that access the backup media. The NetWorker® management console software provides a graphic user interface for functions such as client configuration, policy settings, schedules, monitoring, reports, and daily operations for deduplicated and non-deduplicated backups.

The core NetWorker® software backs up client file systems and operating system environments. Add-on database and application modules provide backup services for products such as Microsoft® Exchange Server. Client backup data may be sent to a remote NetWorker® storage node or stored on a locally attached device using a dedicated storage node. Dell Corporation's NetWorker® modules for Microsoft® applications supports Microsoft® products such as Microsoft® Exchange, Microsoft® Sharepoint, Microsoft® SQL Server, and Microsoft® Hyper-V servers.

The backup/restore application 420 may be Dell Corporation's Avamar® backup/restore application, which provides fast, efficient backup and recovery through a complete software and hardware solution. Equipped with integrated variable-length deduplication technology, Dell Corporation's Avamar® backup/restore application facilitates fast, periodic full backups for virtual environments, remote offices, enterprise applications, network access servers, and desktops/laptops. Data deduplication significantly reduces backup time by only storing unique periodic changes, while always maintaining periodic full backups for an immediate single step restore. The transmission of deduplicated backup sends only changed blocks, reducing network traffic.

Dell Corporation's Avamar® backup/restore application leverages existing local area network and wide area network bandwidth for enterprise-wide and remote/branch office backup and recovery. Every backup is a full backup, which makes it easy for users to browse, point, and click for a single-step recovery. Dell Corporation's Avamar® data store features redundant power and networking, redundant array of independent disks, and redundant array of inexpensive nodes technology to provide uninterrupted data accessibility. Periodic checks of data systems ensure recoverability whenever needed. Dell Corporation's Avamar® systems may be deployed in an integrated solution with Dell Corporation's Data Domain® systems for high-speed backup and recovery of specific data types.

The backup/restore application 420 may use different policies for various data protection levels, such as a “gold” policy for VMware® clients, a “platinum” policy for UNIX® clients, and a “silver” policy for Windows® clients. The gold policy can specify to store two backup copies for each VMware® client's application resources onto the first disk for six months, store a primary clone of the backup copies onto the second disk for one year, and store a secondary clone of the backup copies onto a tape for five years. In another example, a policy can provide redundancy by specifying to replicate each full backup copy to three different backups servers, replicate each incremental cumulative backup copy and each incremental differential backup copy to two different data protection servers, replicate each archive log backup copy to an additional data protection server, and relocate each full backup copy created at the end of the month to cloud tiering for long term retention. Backup copies stored in the cloud tiering have higher costs associated with storing and accessing the data in the backup copies. A policy's start time can specify the start times for creating a backup copy of an application resource, such as 12:00, 13:00, 14:00, and 15:00, for an hourly backup copy, a policy's retention policy can specify the length of time that a backup copy is retained before the backup copy is destroyed, such as a week, a month, or a year, and a policy's destination pool can include the target storage device where backup copies are stored.

Having described the subject matter in detail, an exemplary hardware device in which the subject matter may be implemented shall be described. Those of ordinary skill in the art will appreciate that the elements illustrated in FIG. 6 may vary depending on the system implementation. With reference to FIG. 6, an exemplary system for implementing the subject matter disclosed herein includes a hardware device 600, including a processing unit 602, memory 604, storage 606, a data entry module 608, a display adapter 610, a communication interface 612, and a bus 614 that couples each of the elements 604-612 to the processing unit 602.

The bus 614 may comprise any type of bus architecture. Examples include a memory bus, a peripheral bus, a local bus, etc. The processing unit 602 is an instruction execution machine, apparatus, or device and may comprise a microprocessor, a digital signal processor, a graphics processing unit, an application specific integrated circuit (ASIC), a field programmable gate array (FPGA), etc. The processing unit 602 may be configured to execute program instructions stored in the memory 604 and/or the storage 606 and/or received via the data entry module 608.

The memory 604 may include read only memory (ROM) 616 and random-access memory (RAM) 618. The memory 604 may be configured to store program instructions and data during operation of the hardware device 600. In various embodiments, the memory 604 may include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 604 may also include nonvolatile memory technologies such as nonvolatile flash RAM (NVRAM) or ROM. In some embodiments, it is contemplated that the memory 604 may include a combination of technologies such as the foregoing, as well as other technologies not specifically mentioned. When the subject matter is implemented in a computer system, a basic input/output system (BIOS) 620, containing the basic routines that help to transfer information between elements within the computer system, such as during start-up, is stored in the ROM 616.

The storage 606 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD, or other optical media. The drives and their associated computer-readable media provide nonvolatile storage of computer readable instructions, data structures, program modules and other data for the hardware device 600. It is noted that the methods described herein may be embodied in executable instructions stored in a computer readable medium for use by or in connection with an instruction execution machine, apparatus, or device, such as a computer-based or processor-containing machine, apparatus, or device.

It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for conducting the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and any similar devices.

A number of program modules may be stored on the storage 606, the ROM 616 or the RAM 618, including an operating system 622, one or more applications programs 624, program data 626, and other program modules 628. A user may enter commands and information into the hardware device 600 through the data entry module 608. The data entry module 608 may include mechanisms such as a keyboard, a touch screen, a pointing device, etc. Other external input devices (not shown) are connected to the hardware device 600 via an external data entry interface 630.

By way of example and not limitation, external input devices may include a microphone, joystick, game pad, satellite dish, scanner, or the like. In some embodiments, external input devices may include video or audio input devices such as a video camera, a still camera, etc. The data entry module 608 may be configured to receive input from one or more users of the hardware device 600 and to deliver such input to the processing unit 602 and/or the memory 604 via the bus 614.

A display 632 is also connected to the bus 614 via the display adapter 610. The display 632 may be configured to display output of the hardware device 600 to one or more users. In some embodiments, a given device such as a touch screen, for example, may function as both the data entry module 608 and the display 632. External display devices may also be connected to the bus 614 via an external display interface 634. Other peripheral output devices, which are not depicted in FIG. 6, such as speakers and printers, may be connected to the hardware device 600.

The hardware device 600 may operate in a networked environment using logical connections to one or more remote nodes (not shown) via the communication interface 612. The remote node may be another computer, a server, a router, a peer device, or other common network node, and typically includes many or all the elements described above relative to the hardware device 600. The communication interface 612 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 612 may include logic configured to support direct memory access (DMA) transfers between the memory 604 and other devices.

In a networked environment, program modules depicted relative to the hardware device 600, or portions thereof, may be stored in a remote storage device, such as, for example, on a server. It will be appreciated that other hardware devices and/or software may be used to establish a communications link between the hardware device 600 and each of the other hardware devices.

The arrangement of the hardware device 600 illustrated in FIG. 6 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 600.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 6.

Other components may be implemented in software, hardware, or a combination of software and hardware. Moreover, some or all these other components may be combined, some may be omitted altogether, and additional components may be added while still achieving the functionality described herein. Thus, the subject matter described herein may be embodied in many different variations, and all such variations are contemplated to be within the scope of what is claimed.

In the description herein, the subject matter is described with reference to acts and symbolic representations of operations that are performed by one or more devices, unless indicated otherwise. As such, it is understood that such acts and operations, which are at times referred to as being computer-executed, include the manipulation by the processing unit in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have properties defined by the format of the data. However, while the subject matter is described in this context, it is not meant to be limiting as those of skill in the art will appreciate that various of the acts and operations described herein may also be implemented in hardware.

To facilitate an understanding of the subject matter described, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation to encompass all such modifications and similar arrangements.

1. A system for creating and using disposable copies of backup savesets, comprising:
one or more processors; and
a non-transitory computer readable medium storing a plurality of instructions, which when executed, cause the one or more processors to:
read backup data for an application from a host storage for a host of the application;
write a first copy of the backup data as a backup saveset to a primary backup storage for the application;
store information in a backup index which maps segments of the backup saveset to an object in the primary backup storage which stores the segments of the backup saveset;
write a second copy of the backup data as a disposable copy of the backup saveset to a disposable copy storage for the application, the second copy being the same backup data as the first copy;
store information in the backup index which maps segments of the disposable copy of the backup saveset to an object in the disposable copy storage which stores the segments of the disposable copy;
identify, using the backup index, a segment of the backup saveset which corresponds to a segment of the disposable copy which is identified as having a problem, in response to receiving feedback, which identifies the problem in the segment of the disposable copy, from an analysis engine that is enabled to access and analyze the segments of the disposable copy in the disposable copy storage; and
respond to the problem using the segment of the backup saveset.

2. The system of claim 1, wherein the primary backup storage is inaccessible by the analysis engine that identifies the problem based on matching signatures for malware and the segment of the disposable copy, and responding to the problem comprises isolating the segment of the backup saveset.

3. The system of claim 1, wherein writing the first copy of the backup data to the primary backup storage is concurrent with writing the second copy of the backup data to the disposable copy storage.

4. The system of claim 1, wherein the disposable copy of the backup saveset is associated with a retention time that is shorter than a retention time that is associated with the backup saveset.

5. The system of claim 1, wherein the disposable copy storage is associated with a resource that is inexpensive, including a storage capacity that is smaller, compared to a resource that is associated with the primary backup storage.

6. The system of claim 1, wherein the feedback associating the segment of the disposable copy with the problem is provided by the analysis engine via at least one of an application programming interface, a command line interface, or a representational state transfer (REST).

7. The system of claim 1, wherein the plurality of instructions, when executed, will further cause the one or more processors to delete the segment of the disposable copy from the disposable copy storage, in response to the analysis engine analyzing the segment of the disposable copy.

8. A computer-implemented method for creating and using disposable copies of backup savesets, comprising:
reading backup data for an application from a host storage for a host of the application;
writing a first copy of the backup data as a backup saveset to a primary backup storage for the application;
storing information in a backup index which maps segments of the backup saveset to an object in the primary backup storage which stores the segments of the copy;
writing a second copy of the backup data as a disposable copy of the backup saveset to a disposable copy storage for the application, the second copy being the same backup data as the first copy;
storing information in the backup index which maps segments of the disposable copy of the backup saveset to an object in the disposable copy storage which stores the segments of the disposable copy;
identifying, using the backup index, a segment of the backup saveset which corresponds to a segment of the disposable copy which is identified as having a problem, in response to receiving feedback, which identifies the problem in the segment of the disposable copy, from an analysis engine that is enabled to access and analyze the segments of the disposable copy in the disposable copy storage; and
responding to the problem using the segment of the backup saveset.

9. The computer-implemented method of claim 8, wherein the primary backup storage is inaccessible by the analysis engine that identifies the problem based on matching signatures for malware and the segment of the disposable copy, and responding to the problem comprises isolating the segment of the backup saveset.

10. The computer-implemented method of claim 8, wherein writing the first copy of the backup data to the primary backup storage is concurrent with writing the second copy of the backup data to the disposable copy storage.

11. The computer-implemented method of claim 8, wherein the disposable copy of the backup saveset is associated with a retention time that is shorter than a retention time that is associated with the backup saveset.

12. The computer-implemented method of claim 8, wherein the disposable copy storage is associated with a resource that is inexpensive, including a storage capacity that is smaller, compared to a resource that is associated with the primary backup storage.

13. The computer-implemented method of claim 8, wherein the feedback associating the segment of the disposable copy with the problem is provided by the analysis engine via at least one of an application programming interface, a command line interface, or a representational state transfer (REST).

14. The computer-implemented method of claim 8, wherein the computer-implemented method further comprises deleting the segment of the disposable copy from the disposable copy storage in response to the analysis engine analyzing the segment of the disposable copy.

15. A computer program product, comprising a non-transitory computer-readable medium having a computer-readable program code embodied therein to be executed by one or more processors, the program code including instructions to:
read backup data for an application from a host storage for a host of the application;
write a first copy of the backup data as a backup saveset to a primary backup storage for the application, the second copy being the same backup data as the first copy;
store information in a backup index which maps segments of the backup saveset to an object in the primary backup storage which stores the segments of the backup saveset;
write a second copy of the backup data as a disposable copy of the backup saveset to a disposable copy storage for the application;
store information in the backup index which maps segments of the disposable copy of the backup saveset to an object in the disposable copy storage which stores the segments of the disposable copy;
identify, using the backup index, a segment of the backup saveset which corresponds to a segment of the disposable copy which is identified as having a problem, in response to receiving feedback, which identifies the problem in the segment of the disposable copy, from an analysis engine that is enabled to access and analyze the segments of the disposable copy in the disposable copy storage; and
respond to the problem using the segment of the backup saveset.

16. The computer program product of claim 15, wherein the primary backup storage is inaccessible by the analysis engine that identifies the problem based on matching signatures for malware and the segment of the disposable copy, and responding to the problem comprises isolating the segment of the backup saveset.

17. The computer program product of claim 15, wherein writing the first copy of the backup data to the primary backup storage is concurrent with writing the second copy of the backup data to the disposable copy storage.

18. The computer program product of claim 15, wherein the disposable copy of the backup saveset is associated with a retention time that is shorter than a retention time that is associated with the backup saveset, and is associated with a resource that is inexpensive, including a storage capacity that is smaller, compared to a resource that is associated with the primary backup storage.

19. The computer program product of claim 15, wherein the feedback associating the segment of the disposable copy with the problem is provided by the analysis engine via at least one of an application programming interface, a command line interface, or a representational state transfer (REST).

20. The computer program product of claim 15, wherein the program code includes further instructions to delete the segment of the disposable copy from the disposable copy storage, in response to the analysis engine analyzing the segment of the disposable copy.
